(19) United States
(12) Patent Application Publication
(10) Pub. No.: US 2010/0079666 A1
(43) Pub. Date: Apr. 1, 2010

(54) VIDEO PROCESSING APPARATUS AND VIDEO PROCESSING METHOD

(75) Inventor: Takashi OSANAI, Kumagaya-shi (JP)

Correspondence Address: MCDERMOTT WILL & EMERY LLP, 18191 VON KARMAN AVE., SUITE 500, IRVINE, CA, 92612-7108, US

(73) Assignee: KABUSHIKI KAISHA TOSHIBA, Tokyo (JP)

(21) Appl. No.: 12/506,208

(22) Filed: Jul. 20, 2009

(30) Foreign Application Priority Data
Sep. 30, 2008 (JP) 2008-255200

(51) Int. Cl. H04N 7/01

(52) U.S. Cl. 348/441; 348/E07.003

(57) ABSTRACT

According to one embodiment, a video processing apparatus which is connectable to an external apparatus having a function of converting a video signal of a first resolution into a video signal of a second resolution higher than the first resolution by inserting pixels with a predetermined luminance value includes an up-convert module. The up-convert module executes up-convert processing for a region extracted by excluding the pixels inserted by the external apparatus in the video signal of the second resolution supplied from the external apparatus.

### CROSS-REFERENCE TO RELATED APPLICATIONS

This application is based upon and claims the benefit of priority from Japanese Patent Application No. 2008-255200, filed Sep. 30, 2008, the entire contents of which are incorporated herein by reference.

### BACKGROUND

1. Field

One embodiment of the invention relates to a video processing apparatus and video processing method, which have an up-convert function.

2. Description of the Related Art

Nowadays, video signals used in video input and output devices and broadcasting are of a mixture of various formats due to their diversification. For example, an HD (High Definition) image quality such as a video signal having a resolution of 1920×1080 used in BS digital broadcasting and a video signal having a resolution of 1440×1080 used in terrestrial digital broadcasting, and an SD (Standard Definition) image quality used in DVDs, analog broadcasting, and the like are known. For this reason, when a video recording/playback device such as a DVD recorder is connected to a video display device such as a digital television receiver, conversion of a video signal that matches the transmission specification between the devices, the resolution of the video display device, and the like is required.

For example, a DVD recorder applies up-convert processing that matches the transmission specification to video signals of various formats, and outputs the processed video signals to a digital television receiver. On the other hand, the digital television receiver also has a function of executing the up-convert processing, and some digital television receivers include up-convert processing based on a super-resolution function. The super-resolution function generates new pixel value data between pixels to create high frequency components and to sharpen an image, thus generating an image having a resolution exceeding its original resolution. More specifically, for example, a video signal of the SD image quality used in DVDs and analog broadcasting is converted into that of the HD image quality by interpolating pixels.

Jpn. Pat. Appln. KOKAI Publication No. 2006-287506 discloses an HDTV display apparatus which detects a video signal which has been converted to the resolution of the HD image quality by inserting mask parts at the right and left ends of a video signal of the SD image quality, up-converts a part (valid video) of the video signal of the SD image quality extracted by removing the mask parts at the right and left ends from this video signal of the HD image quality, and outputs the up-converted video signal.

As described above, the HDTV display apparatus of Jpn. Pat. Appln. KOKAI Publication No. 2006-287506 has a function of detecting a video signal generated by inserting mask parts into a video signal of the SD image quality, and executing up-convert processing of that video signal. However, when a video signal input to the HDTV display apparatus has already undergone the up-convert processing, the HDTV display apparatus skips execution of the up-convert processing. Therefore, in such case, the function of the up-convert processing included in the HDTV display apparatus cannot be used.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view for explaining up-convert processing executed by a conventional video processing apparatus;

FIG. 2 is an exemplary view for explaining up-convert processing executed by a video processing apparatus according to an embodiment of the invention;

FIG. 3 is an exemplary flowchart for explaining the procedure of up-convert processing executed by the video processing apparatus according to the embodiment; and

FIG. 4 is an exemplary block diagram showing the arrangement of the video processing apparatus according to the embodiment of the invention.

### DETAILED DESCRIPTION

Various embodiments according to the invention will be described hereinafter with reference to the accompanying drawings. In general, according to one embodiment of the invention, there is provided a video processing apparatus which is connectable to an external apparatus having a function of converting a video signal of a first resolution into a video signal of a second resolution higher than the first resolution by inserting pixels with a predetermined luminance value, the video processing apparatus comprising: an up convert module configured to execute up convert processing for a region extracted by excluding the pixels inserted by the external apparatus in the video signal of the second resolution supplied from the external apparatus.

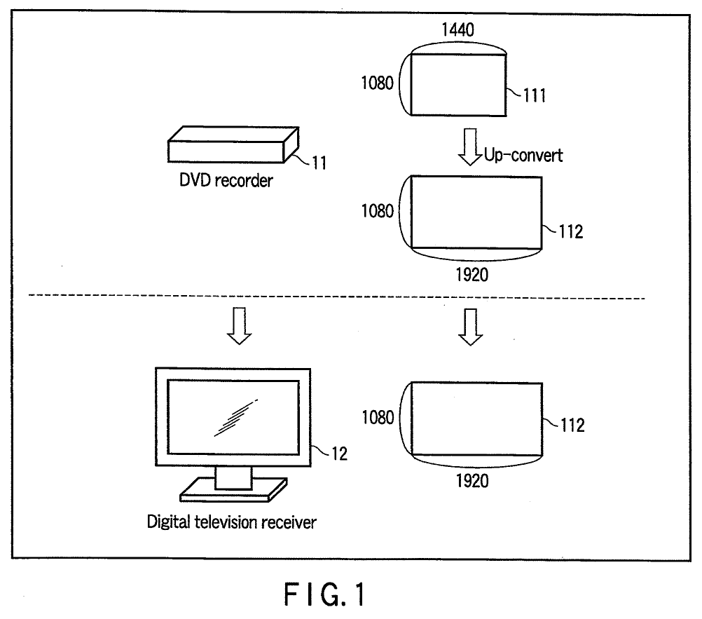

The sequence of up-convert processing of a video signal in a conventional video processing apparatus will be described first with reference to FIG. 1.

This video processing apparatus is implemented as, for example, a video recording/playback apparatus such as a DVD recorder, a set-top box, a video display apparatus such as a digital television receiver, or combinations of these. FIG. 1 shows the video processing apparatus including a DVD recorder 11 and digital television receiver 12. In FIG. 1, assume that the DVD recorder 11 plays back a video signal having a resolution of 1440×1080, and the digital television receiver 12 displays a video signal having a resolution of 1920×1080.

The DVD recorder 11 and digital television receiver 12 are connected via an interface complying with, e.g., a High-Definition Multimedia Interface (HDMI) specification (to be referred to as an HDMI interface hereinafter). With this HDMI interface, a video signal communication is made. The HDMI specification further specifies a Consumer Electronics Control (CEC) specification. Therefore, the HDMI interface includes a two-way communication module of control signal and the like, which complies with the CEC. In this case, assume that it is specified to transmit a video signal having a resolution of 1920×1080 from the DVD recorder 11 to the digital television receiver 12.

The DVD recorder 11 plays back, for example, recorded terrestrial digital broadcast content. The terrestrial digital broadcast content as a video source has a resolution of 1440×1080, as indicated by a video frame 111. The DVD recorder 11 executes up-convert processing for the video frame 111, and converts the video frame 111 into a video frame 112 having a resolution of 1920×1080, so as to transmit a video signal having a resolution of 1920×1080 to the digital television receiver 12. The DVD recorder 11 transmits the video frame 112 to the digital television receiver 12.

The digital television receiver 12 displays a video on the screen based on the video frame 112 received from the DVD recorder 11.

With the aforementioned processing, the DVD recorder 11 applies up-convert processing to a video signal (video source) having a resolution of 1440×1080, and transmits the converted video signal to the digital television receiver 12. The digital television receiver 12 can display a video on the screen having a resolution of 1920×1080.

However, with this method, even when the digital television receiver 12 has a function of executing up-convert processing, since the DVD recorder 11 has already applied the up-convert processing to the video signal, execution of the up-convert processing in the digital television receiver 12 is skipped. For this reason, when the up-convert processing included in the digital television receiver 12 is processing better suited to display on the digital television receiver 12 than that included in the DVD recorder 11 or is more advanced function processing including a super-resolution function or the like, often, optimal up-convert processing cannot be applied to the video signal.

Hence, the video processing apparatus of this embodiment executes control required to skip execution of the up-convert processing included in the DVD recorder 11 and to execute the up-convert processing included in the digital television receiver 12. However, the playback content of the DVD recorder 11 has a resolution of 1440×1080, which is not the resolution specified by the transmission specification between the apparatuses. Therefore, in order to transmit a video signal of a video source from the DVD recorder 11 to the digital television receiver 12, the DVD recorder 11 has to execute substitute processing for converting the video signal into that having the resolution specified in transmission in place of the up-convert processing for the video signal.

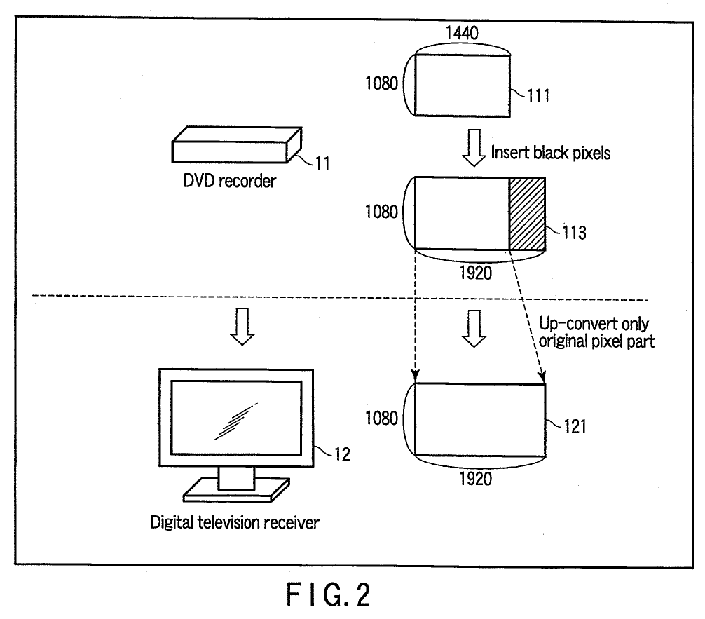

FIG. 2 shows the sequence of up-convert processing of a video signal in the video processing apparatus according to the embodiment of the invention. The arrangement of the video processing apparatus, the connection between the devices that configure the video processing apparatus, the resolution of a video source to be played back by the DVD recorder 11, the resolution of a video signal to be exchanged between the devices, and the like are as have been described using FIG. 1.

In this embodiment, the DVD recorder 11 plays back, for example, recorded terrestrial digital broadcast content. The resolution of the terrestrial digital broadcast content as a video source is 1440×1080, as indicated by the video frame 111. The DVD recorder 11 inserts band-shaped black pixels (pixels with a luminance value=0) to the right end of the video frame 111 having the resolution of 1440×1080 to generate a video frame 113, so as to transmit a video signal having a resolution of 1920×1080, which is specified in transmission, to the digital television receiver 12. That is, the DVD recorder 11 inserts a band-shaped black pixels having a resolution of 480×1080 to the right end of the video frame 111 having a resolution of 1440×1080 to generate the video frame 113 having a resolution of 1920×1080.

In this case, the band-shaped black pixels are inserted to the right end of the video frame 111. Alternatively, any other method may be used as long as a method of inserting black pixels to generate a video frame 113 having a resolution of 1920×1080 is used (for example, the black pixels are inserted to the left end or are evenly inserted to the right and left ends).

The DVD recorder 11 transmits this video frame 113 to the digital television receiver 12. Also, the DVD recorder 11 transmits the resolution of the video frame 111 and the luminance value of the inserted pixels to the digital television receiver 12.

The digital television receiver 12 receives the video frame 113 from the DVD recorder 11. The digital television receiver 12 applies up-convert processing to a part obtained by excluding the black pixels inserted by the DVD recorder 11 from the video frame 113, i.e., a part (the resolution of 1440×1080) corresponding to the original video frame 111, thus obtaining a video frame 121 having a resolution of 1920×1080.

With the aforementioned processing, the up-convert processing included in the digital television receiver 12 can be applied to the original video signal in place of that included in the DVD recorder 11. This method is suitable, for example, when the up-convert processing included in the digital television receiver 12 is better suited to display of a video on the digital television receiver 12 than that included in the DVD recorder 11 or when the digital television receiver 12 further includes advanced function processing such as a super-resolution function.

Note that super-resolution processing based on the super-resolution function generates a video signal of a second resolution by creating new pixel values from a video signal of a first resolution lower than the second resolution. The super-resolution processing based on the super-resolution function executes sharpening processing for reproducing an image signal of the second resolution by estimating original pixel values from an image signal of the first resolution to increase the number of pixels. Note that “original pixel values” indicates the values of respective pixels of an image signal obtained when a camera of a high resolution (second resolution) picks up an image of the same object as that when the image signal of a low resolution (first resolution) is obtained. Also, “estimate to increase the number of pixels” means that original pixel values are estimated based on an intra-frame image or inter-frame images with a high correlation by detecting a feature of a target image, and these pixel values are determined as those which are to be associated with new pixels. That is, image correlation is used. Note that the super-resolution processing can use known and public techniques disclosed in, for example, Jpn. Pat. Appln. KOKAI Publication Nos. 2007-310837, 2008-98803, and 2000-188680. As the technique for the super-resolution processing of this embodiment, for example, a technique for reproducing an image having frequency components higher than a Nyquist frequency determined by the sampling period of an input image can be used.

For example, when super-resolution processing disclosed in Jpn. Pat. Appln. KOKAI Publication No. 2007-310837 is used, an image region of interest including a pixel of interest in a frame is set for each of a plurality of medium-resolution frames. A plurality of corresponding points corresponding to a plurality of image regions of interest, which are closest to a change pattern of pixel values in the image region of interest are selected from the reference frame, and the luminance sample value of each corresponding point is set as a pixel value of the pixel of interest corresponding to the corresponding point. Based on the magnitudes of the plurality of sample values and the layout of the plurality of corresponding points, the pixel values of a high-resolution frame which includes pixels more than those of the reference frame and corresponds to the reference frame are calculated. As a result, the number of pixels is increased by estimating original pixel values from an image signal of a low resolution, and an image signal of a high resolution is reproduced.

On the other hand, when super-resolution processing using a self congruent position search in a single frame image disclosed in Jpn. Pat. Appln. KOKAI Publication No. 2008-98803 is used, a first pixel position with a minimum error is calculated by comparing errors of respective pixels in a search region of a medium-resolution frame. Next, a position with a minimum error in the search region is calculated to a decimal precision based on the first pixel position, a first error at that position, second pixel position around the first pixel, and a second error at the position. Then, a decimal precision vector having this position as an end point and a pixel of interest as a start point is calculated, and an extrapolation vector of the decimal precision vector, having a pixel on a screen, which is not included in the search region, as an end point, is calculated using the decimal precision vector. Then, based on the decimal precision vector, extrapolation vector, image signal, and pixel values acquired from the pixel values of a high-resolution image having pixels the number of which is larger than those included in the image signal are calculated. The super-resolution processing increases the number of pixels by estimating original pixel values from an image signal of a low resolution by executing the aforementioned processing, thereby restoring an image signal of a high resolution.

Also, super-resolution processing that uses mapping between a plurality of frame images disclosed in Jpn. Pat. Appln. KOKAI Publication No. 2000-188680 can be used.

In addition, in the super-resolution processing of this embodiment, by adding a unique algorithm, a stretched video is temporarily converted into a low-resolution video, differences are detected by comparing the low-resolution video with the original input video, and correction processing based on the detected differences is applied, thus also implementing image quality processing.

However, the method of the super-resolution processing of this embodiment is not limited to the aforementioned methods, and any other method can be applied as long as processing for reproducing an image signal of a high resolution by estimating new pixel values from an image signal of a low resolution to increase the number of pixels and the sharpening processing are executed.

In the above description, a video signal having a resolution of 1440×1080 is up-converted into that having a resolution of 1920×1080. However, the resolutions of respective video signals are not limited to those described above, and the aforementioned method can be applied when the resolution of a video signal to be played back by the DVD recorder 11 is smaller than that of a video signal to be displayed on the digital television receiver 12. In this case, the method of insertion of black pixels in the DVD recorder 11 is changed according to the relationship among the resolution of the video frame 111 in the DVD recorder 11, that of the video frame 121 in the digital television receiver 12, and that specified in transmission of a video signal from the DVD recorder 11 to the digital television receiver 12. For example, in addition to the aforementioned method of inserting the band-shaped black pixels to the right or left end, a method of inserting a band-shaped black pixels to the top or bottom end is used as needed. When the resolution of the video frame 111 in the DVD recorder 11 matches that specified in transmission of a video signal, the DVD recorder 11 does not insert any black pixels, and transmits the video frame 111 intact to the digital television receiver 12.

Note that each pixel which forms the band-shaped pixels to be inserted is not limited to the aforementioned black pixel (that having a luminance value=0), and may be a pixel having a predetermined luminance value specified in advance between the DVD recorder 11 and digital television receiver 12. Furthermore, the luminance value to be set in each pixel to be inserted is not limited to a predetermined luminance value. That is, a certain device determines a luminance value to be set in each pixel to be inserted, and transmits this value to another device using the CEC of the HDMI interface or the like, thereby specifying the predetermined luminance value between the DVD recorder 11 and digital television receiver 12.

Therefore, the digital television receiver 12 is connected to the DVD recorder 11 which has a function of converting a video signal of a first resolution into that of a second resolution higher than the first resolution by inserting pixels set with a predetermined luminance value. The digital television receiver 12 executes up-convert processing for a region obtained by excluding the pixels inserted by the DVD recorder 11 in the video signal of the second resolution. The DVD recorder 11 can be connected to the digital television receiver 12, has an up-convert function of increasing the resolution of an input video signal, and outputting that video signal, and a pixel insertion function of converting a video signal of the first resolution into that of the second resolution by inserting pixels set with a predetermined luminance value. The DVD recorder 11 controls to disable the up-convert function and to enable the pixel insertion function when the digital television receiver 12 has the up-convert function.

In other words, there is provided the video processing apparatus including the DVD recorder 11 which outputs a video signal of the second resolution higher than the first resolution, and the digital television receiver 12 which receives the video signal of the second resolution. The DVD recorder 11 converts a video signal of the first resolution into that of the second resolution by inserting pixels set with a predetermined luminance value and transmits the converted video signal to the digital television receiver 12. The digital television receiver 12 receives the video signal of the second resolution from the DVD recorder 11 and executes up-convert processing for a region obtained by excluding the pixels inserted by the DVD recorder 11 in the received video signal of the second resolution.

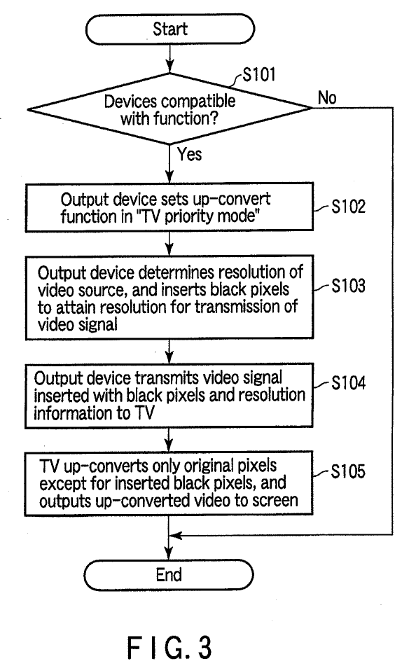

FIG. 3 is a flowchart showing the procedures of the up-convert processing of a video signal in the video processing apparatus of this embodiment. As in FIG. 2, assume that the video processing apparatus includes the DVD recorder 11 as a video output device and the digital television receiver 12 that displays a video. In this embodiment, as described above, although both the DVD recorder 11 and digital television receiver 12 have the up-convert processing function, the DVD recorder 11 skips execution of the up-convert processing, and the digital television receiver 12 executes the up-convert processing.

Each of the DVD recorder 11 and digital television receiver 12 determines if a partner device has a function of controlling execution of up-convert processing (block S101). In block S101, for example, the DVD recorder 11 notifies the digital television receiver 12 of information indicating whether or not the DVD recorder 11 has the function of controlling execution of up-convert processing, and the digital television receiver 12 notifies the DVD recorder 11 of information indicating whether or not the digital television receiver 12 has the function of controlling execution of up-convert processing, thereby determining in each device if the partner device has that function. If both the DVD recorder 11 and digital television receiver 12 have the function of controlling execution of up-convert processing (YES in block S101), the DVD recorder 11 (output device) sets the up-convert function in a “TV priority mode” (block S102). By setting the up-convert function in the “TV priority mode”, the DVD recorder 11 executes subsequent processes for controlling itself to skip execution of the up-convert processing, and controlling the digital television receiver 12 to execute the up-convert processing.

The DVD recorder 11 determines the resolution of a video to be played back (video source), and inserts black pixels to the video source so as to attain the resolution of a video signal specified in transmission (block S103). In this process, the DVD recorder 11 inserts a band-shaped black pixels to the right end of each video frame included in the video source to convert the video frame to that having the resolution specified in transmission in accordance with the difference between the resolution of the video source and the resolution specified in transmission.

The DVD recorder 11 transmits the video signal inserted with the black pixels and information associated with the resolution to the digital television receiver 12 (block S104). As the information associated with the resolution, the value of the resolution of a video source is transmitted. Based on this information, the digital television receiver 12 can easily extract the original video signal (video source) from the video signal inserted with the black pixels. Note that as the information associated with the resolution, the resolution of the video signal inserted with the black pixels (that specified in transmission), and the size, insertion position, and the like of the inserted band-shaped black pixels may be transmitted. When pixels set with a predetermined luminance value are inserted in place of the black pixels, information of this luminance value may be transmitted.

The digital television receiver 12 executes up-convert processing for the original image part obtained by excluding the inserted black pixels from the video signal received from the DVD recorder 11, thereby outputting a video converted in correspondence with the resolution of the screen to the screen (block S105).

If at least one of the DVD recorder 11 and digital television receiver 12 does not have any function of controlling execution of up-convert processing (NO in block S101), the processing ends.

With the above processing, execution of up-convert processing included in the DVD recorder 11 is skipped for a video signal played back by the DVD recorder 11, and up-convert processing included in the digital television receiver 12 can be applied to that video signal. As described above, this processing is of service when the up-convert processing included in the digital television receiver 12 is more suited to display of a video on the digital television receiver 12 than that included in the DVD recorder 11 or further includes advanced function processing such as a super-resolution function.

Note that in place of transmitting information of the resolution from the DVD recorder 11 to the digital television receiver 12 in block S104, the digital television receiver 12 may have a module configured to extract the original video signal by excluding the inserted black pixels in block S105. That is, in block S105 the digital television receiver 12 extracts the original video signal by excluding the black pixels by detecting the black pixels inserted by the DVD recorder 11 from the video signal received from the DVD recorder 11. Then, the digital television receiver 12 applies up-convert processing to this original video signal.

Also, information indicating that the digital television receiver 12 applies up-convert processing to a video signal, the resolution of a video source, the resolution of the up-converted video signal, and the like may be presented to the user via, e.g., the screen of the digital television receiver 12.

The aforementioned processing is executed by microprocessors and the like respectively included in the DVD recorder 11 and digital television receiver 12.

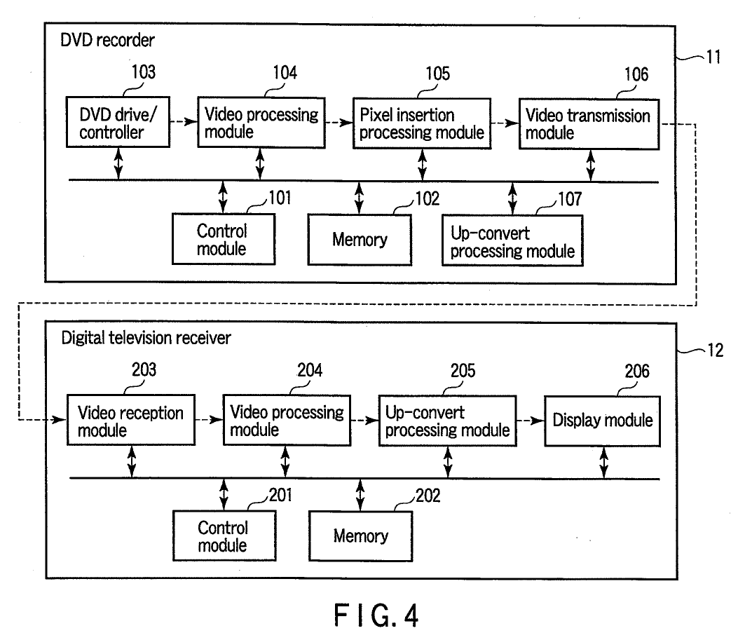

FIG. 4 shows an example of the arrangement of the video processing apparatus according to the embodiment of the invention. This video processing apparatus is implemented as, for example, a video recording/playback apparatus such as a DVD recorder, a set-top box, a video display apparatus such as a digital television receiver, or combinations of these. FIG. 4 shows an example of the video processing apparatus including the DVD recorder 11 and digital television receiver 12. The DVD recorder 11 and digital television receiver 12 respectively have the function of executing up-convert processing for a video signal.

The DVD recorder 11 and digital television receiver 12 are connected via an interface complying with a predetermined communication specification, e.g., the HDMI specification. The HDMI interface includes a two-way communication module of control information and the like, which complies with the CEC.

The DVD recorder 11 includes a control module 101, memory 102, DVD drive/controller 103, video processing module 104, pixel insertion processing module 105, video transmission module 106, and up-convert processing module 107.

The control module 101 controls the operations of respective modules in the DVD recorder 11. The memory 102 is a main memory which stores various kinds of setting information and control information.

The DVD drive/controller 103 executes processing for, e.g., playing back, stopping, and recording video content under the control of the control module 101 based on a user's operation or the like using a DVD on which video content is recorded or that used to record video content. Upon playing back the video content, the DVD drive/controller 103 outputs a video signal of the played-back video content to the video processing module 104.

The video processing module 104 applies predetermined digital video signal processing to the input video signal, and outputs the processed video signal to the pixel insertion processing module 105 or up-convert processing module 107. The digital video signal processing includes, for example, decode processing for a compressed video signal.

The pixel insertion processing module 105 executes processing for converting an image size by inserting a pixels into the input video signal. When the resolution of the video signal played back is different from that specified in transmission to the digital television receiver 12, the pixel insertion processing module 105 inserts black pixels (those with a luminance value=0) or the like to match these resolutions. The pixel insertion processing module 105 generates a video having a resolution (image size) that meets the transmission specification by inserting, e.g., a band-shaped black pixels to the end portion of a video without increasing the resolution of the original video, thus allowing the video to be transmitted to the digital television receiver 12. The pixel insertion processing module 105 outputs the video signal inserted with the pixels to the video transmission module 106.

The video transmission module 106 is connected to a video reception module 203 included in the digital television receiver 12, and exchanges video signals and control signals complying with HDMI. The video transmission module 106 transmits the video signal input from the pixel insertion processing module 105 or up-convert processing module 107 to the digital television receiver 12 via the video reception module 203.

The up-convert processing module 107 executes up-convert processing to the video signal input from the video processing module 104. When the resolution of a video signal played back by the DVD recorder 11 is different from that of a video to be displayed on a display module 206 of the digital television receiver 12 or it is different from that of a video specified in transmission to the digital television receiver 12, the up-convert processing module 107 executes up-convert processing to match these resolutions of the video. The up-convert processing module 107 outputs the up-converted video signal to the video transmission module 106.

The control module 101 controls one of the pixel insertion processing module 105 and up-convert processing module 107 to execute processing for converting the resolution of a video played back by the DVD recorder 11. When the digital television receiver 12 includes the up-convert function, the DVD recorder 11 converts the resolution of a video by inserting pixels using the pixel insertion processing module 105 and skips execution of the up-convert processing by the up-convert processing module 107.

The digital television receiver 12 includes a control module 201, memory 202, video reception module 203, video processing module 204, up-convert processing module 205, and display module 206.

The control module 201 controls the operations of respective modules in the digital television receiver 12. The memory 202 is a main memory which stores various kinds of setting information and control information.

The video reception module 203 is connected to the video transmission module 106 included in the DVD recorder 11, and exchanges video signals and control signals complying with HDMI. The video reception module 203 receives the video signal output from the DVD recorder via the video transmission module 106. The video reception module 203 outputs the received video signal to the video processing module 204.

The video processing module 204 applies predetermined digital video signal processing to the video signal input from the video reception module 203, and outputs the processed video signal to the up-convert processing module 205.

The up-convert processing module 205 executes up-convert processing to the video signal input from the video processing module 204. The up-convert processing module 205 executes up-conversion so as to match the resolution of the input video signal with that of a video to be displayed on the display module 206. When the input video signal is a video generated by inserting black pixels by the pixel insertion processing module 105 of the DVD recorder 11, the up-convert processing module 205 executes up-convert processing on the original video part by excluding the inserted black pixels. In this manner, a video signal that undergoes the up-convert processing in only the digital television receiver 12 can be generated.

The display module 206 displays a video based on the video signal output from the up-convert processing module 205 on the screen. The display module 206 displays, on the screen, information indicating the value of the resolution of the original video signal, information indicating the value of the resolution of the video signal displayed on the screen, information indicating that the up-convert processing has been executed, or the like.

With the above arrangement, when both the DVD recorder 11 and digital television receiver 12 have the up-convert function, they can be controlled so that the DVD recorder 11 skips execution of the up-convert processing, and only the digital television receiver 12 executes the up-convert processing.

As described above, according to this embodiment, an apparatus other than a predetermined video processing apparatus can be controlled to be inhibited from executing up-convert processing for a video signal. When the predetermined video processing apparatus is a device on the video receiving side such as the digital television receiver 12, a video processing apparatus on the video transmitting side such as the DVD recorder 11 applies substitute processing required to transmit a video signal between the devices in place of the up-convert processing, thus allowing the predetermined device to execute the up-convert processing. In particular, when the resolution specified in transmission is larger than that of the original video signal (video source), processing for inserting a band-shaped black pixels into the end portion of the original video signal based on their difference and converting the original video signal into a video having a resolution specified in transmission is executed as the substitute processing.

Therefore, the video processing apparatus of this embodiment need only include a function of executing up-convert processing for a video signal, and a function of executing pre-processing for the up-convert processing.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processing apparatus which is connectable to an external apparatus having a function of converting a video signal of a first resolution into a video signal of a second resolution higher than the first resolution by inserting pixels with a predetermined luminance value, the video processing apparatus comprising:
an up-convert module configured to execute up-convert processing for a region extracted by excluding the pixels inserted by the external apparatus in the video signal of the second resolution supplied from the external apparatus.

2. The apparatus of claim 1, wherein the up-convert module is configured to execute super-resolution processing.

3. The apparatus of claim 1, further comprising a display unit that displays at least one of information indicating the first resolution and the second resolution, and information presenting a message indicating that the up-convert processing is executed.

4. A video processing method for a video processing apparatus which is connectable to an external apparatus having a function of converting a video signal of a first resolution into a video signal of a second resolution higher than the first resolution by inserting pixels with a predetermined luminance value, the method comprising:
executing up-convert processing for a region extracted by excluding the pixels inserted by the external apparatus in the video signal of the second resolution supplied from the external apparatus.

5. A video processing apparatus which is connectable to a display apparatus, the video processing apparatus comprising:
an up-convert module configured to increase a resolution of an input video signal and to output the video signal with an increased resolution;
a pixel insertion module configured to convert a video signal of a first resolution into a video signal of a second resolution higher than the first resolution by inserting pixels with a predetermined luminance value; and
a control module configured to disable the up-convert module and to enable the pixel insertion module when the display apparatus has an up-convert function.
